(19) United States
(12) Patent Application Publication
(10) Pub. No.: US 2016/0078691 A1
(43) Pub. Date: Mar. 17, 2016

(54) PORTABLE VEHICLE DIAGNOSTIC TOOL

(71) Applicant: INTERNATIONAL ENGINE INTELLECTUAL PROPERTY COMPANY, LLC, Lisle, IL (US)

(72) Inventor: Randall R. Roepke, Western Springs, IL (US)

(21) Appl. No.: 14/786,619

(22) PCT Filed: Apr. 23, 2013
(86) PCT No.: PCT/US13/37698

§ 371 Date: Oct. 23, 2015

(51) Int. Cl. G07C 5/08; G07C 5/02; H04W 88/02; G07C 5/00

(52) U.S. Cl. CPC G07C 5/08; G07C 5/008; G07C 5/02; H04W 88/02

(57) ABSTRACT

A diagnostic application for a motor vehicle is incorporated into a handheld device such as a cell phone through a portable application. The handheld device includes video capture and display capability. The application operates to qualify flashes generated on a vehicle instrument cluster by vehicle on-board diagnostics. These flash codes are processed for qualification and decoding resulting in display a textual description corresponding to the vehicle diagnostic flash code.

### BACKGROUND

1. Technical Field

The field relates to vehicle diagnostic tools, and more particularly, to adaptation of an electronic device incorporating video capture capability for use in decoding visually displayed, on-board diagnostic flash codes.

2. Description of the Technical Field

Motor vehicle on-board diagnostics (OBD) exploit the connection of vehicle sensors to centralized vehicle data processing capabilities to assess vehicle operating condition and to make fault estimations which may be stored in memory. Older vehicles and vehicles sold in cost sensitive markets may not be equipped with message displays that allow descriptions of identified potential faults to be displayed in text form. Diagnostic fault codes on some such vehicles have been communicated by flash (or blink) codes displayed on the vehicle instrument cluster. This involves a light or icon flashing on the vehicle's instrument cluster/dash panel according to specific patterns. The fault codes are generally displayed in groups of four digits. The code is displayed by flashing a count equal to each of the four digits with short pauses within a digit and a longer pause between digits. For example, the sequence 1, 2, 3, 4 would result in the icon or light be flashed once, followed by a pause, followed by flashing the light twice, followed again by a pause and so forth. A still longer pause separates distinct fault codes.

In the past technicians have initiated generation of the diagnostic procedure and watched the instrument cluster for generation of the flash codes. Usually an arbitrary sequence of operating vehicle controls results in generation of the codes, for example turning an ignition switch to on followed by pumping the accelerator pedal quickly five times. The technician watches the instrument cluster, counts the flash code for each fault, notes each number and then looks up the fault(s) in an indexed hand book.

### SUMMARY

A diagnostic application for a motor vehicle is incorporated into a handheld device such as a cell phone through an portable application. The handheld device includes video capture and display capability. The application operates to qualify flashes generated on a vehicle instrument cluster by vehicle on-board diagnostics. These flash codes are processed for qualification and decoding resulting in display a textual description corresponding to the vehicle diagnostic flash code.

### BRIEF DESCRIPTION OF THE DRAWINGS

FIG. 1 is a front view of a vehicle dash panel with a portable electronic device such as a cell phone adapted for decoding diagnostic display codes.

FIG. 2 is a block diagram schematic for a video capture circuit of a handheld electronic device.

FIG. 3 is a high level flow chart of an application for an electronic device such as a cell phone to be used for decoding vehicle diagnostic codes.

### DETAILED DESCRIPTION

In the following detailed description, like reference numerals and characters may be used to designate identical, corresponding, or similar components in differing drawing figures. Furthermore, example sizes/models/values/ranges may be given with respect to specific embodiments but are not to be considered generally limiting.

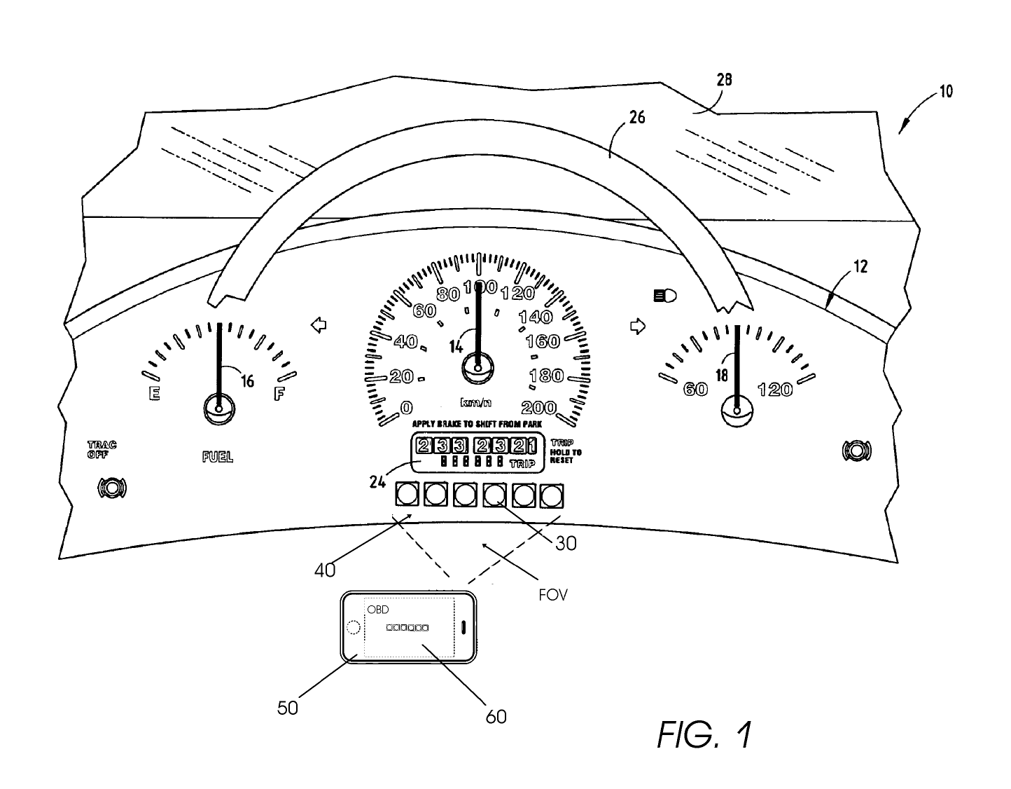

Referring now to the figures and in particular to FIG. 1, an instrument cluster 12 is generally shown located within a passenger compartment 10 of a vehicle. The instrument cluster 12 is usually located at the front of the passenger compartment 10 between a steering wheel 26 and a windscreen 28. The instrument cluster 12 contains various vehicle related instruments represented here by particularly common instruments such as a speedometer 14, a fuel gauge 16, an engine coolant temperature gauge 18 and an odometer 24.

A diagnostic icon 30 is shown as included among a set of warning lights 40, although it can also be in a stand along location on the instrument cluster 12. Upon initiation of a diagnostic operation the diagnostic icon 30 will display visual flash codes for any fault detected, or stored in memory, by an on-board diagnostic (OBD) system (not shown). OBD systems have been common on vehicles since the middle 1990's and are well known in the art.

Shown displaced rearward from the instrument cluster 12 is a handheld electronic device 50 such as a cell phone. Electronic device 50 incorporates video capture facility and further includes a display 60 on which an image from the field of view (FOV) of the video capture facility may be displayed. An icon (OBD) for actuating an application installed on the electronic device 50 may also be displayed on the display 60. In use the electronic device 50 is oriented to capture sequences of images taken of the warning lights 40 and in particular of engine diagnostic icon 30. The video capture rate of such devices is commonly on the order of 30 frames per second which is comfortably fast enough for capture of flash codes displayed on icon 30. The time duration of periods of illumination and the gaps between periods of illumination is on the order of ½ second. The minimum gap between periods of illumination within a digit is on the same order. At least 10 consecutive frames should be captured between each change in icon 30 from an on to an off state or back. Timers built into the diagnostic flash code decoding application installed on the electronic device 50 may be used to determine with of warning lights 40 is the correct light or icon 30 to track.

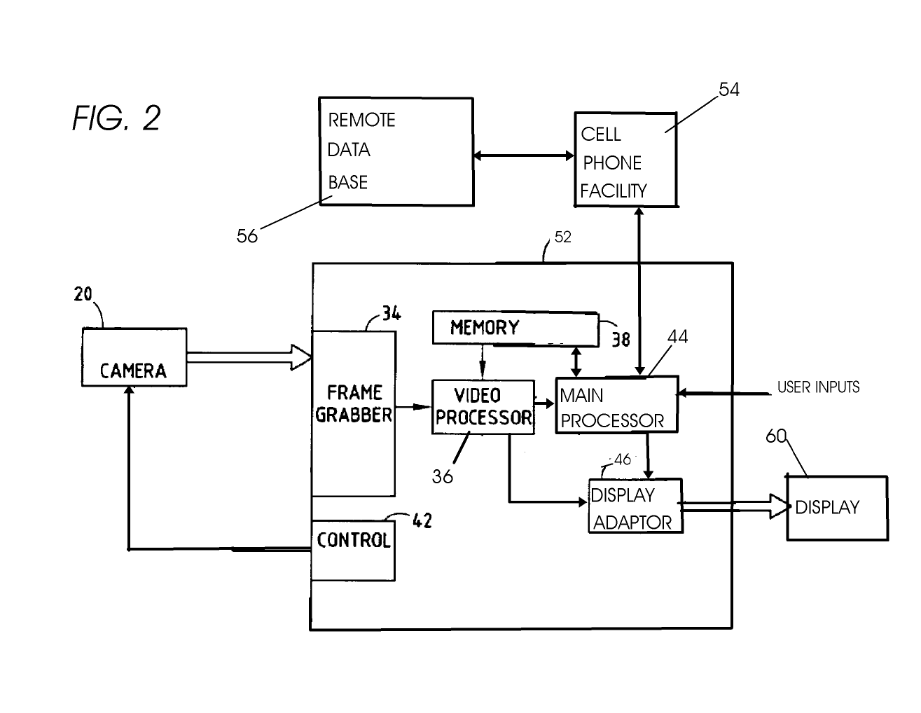

FIG. 2 is a block diagram schematic for a video capture circuit 52 for a handheld electronic device. Video capture circuit 52 receives a series of images from a camera 20 into a frame grabber 34 which buffers the frames for processing by a video processor 36. Video processor 36 provides an image to a display adapter 46 and flash code counts to a main processor 44. Main processor 44 uses the counts to interrogate memory 38 for textual descriptions of any faults. Alternatively, where electronic device 50 includes a cell phone (or cellular telephone) facility 54, then a remote server supporting a remote data base 56 may be accessed by a cellular telephone link to retrieve text messages relating to the codes.

The text messages may be passed to display adapter 46. The display adapter 46 provides outputs to display 60 enabling it to reproduce images in the field of view of camera 20 or messages from the main processor 44. The main processor handles any user inputs relating the process. Control 42 can provide for stabilization of image frames captured by camera 20 and well as brightness control. Video processing and the main processing functions may be combined in a single programmable element. The diagnostic flash code decoding application is installable on the handheld electronic device 50 and includes any timing loops used for identifying areas in the recorded image tracking anticipated patterns for diagnostic flash codes. In other words, the application provides for qualification of a series of flashes occurring in a sequence of image frames as corresponding to display of a diagnostic flash code.

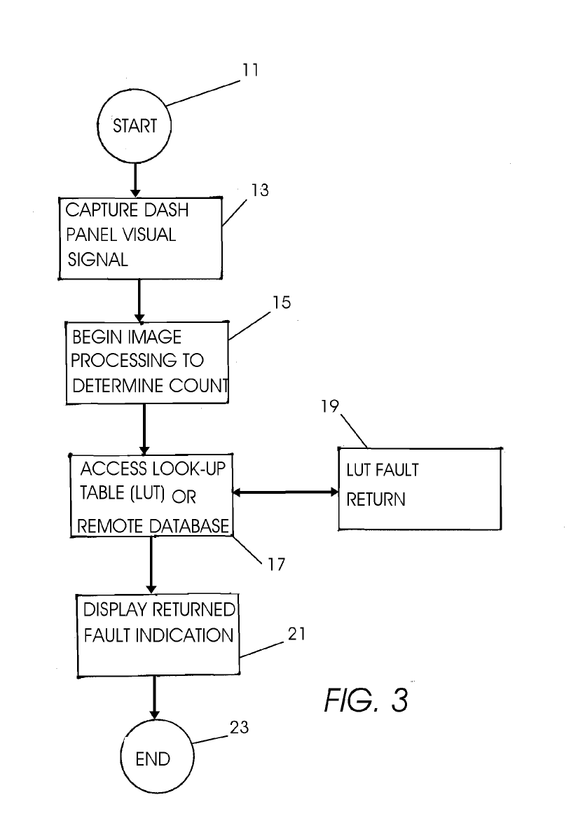

FIG. 3 is a flow chart illustrating operation of the diagnostic flash code decoding application installed on electronic device 50 to be used for identifying flash codes generated by a motor vehicle control system on an instrument cluster 12. After the application is started (step 11) by selection of an icon on the display 60, and positioning of the electronic device 50 to capture images of icon 30, the application must identify and capture the optical signal generated (step 13). This includes location of the icon 30 on the instrument cluster 12 and qualification of light pulses and gaps in the proper location. Image stabilization based on landmarks within the instrument cluster 12 may be provided to keep the location of the flashing icon 30 constant in the captured image. Icon qualification can involve operator steps to select the location of the icon on the display or qualification of a flash appearing in the field of view based on its brightness and, in some cases, color intensity.

The image is processed (step 15) to determine groups of flashes associated with a fault code and flash counts for each digit within a group. Digits and groups of digits may be identified by a timer which starts whenever icon 30 ceases to be illuminated. The period separating flashes associated with a digit is shorter than the gap occurring between termination of the last flash for the last digit of a digit in a group and the first flash for a following digit of the same group. The gap between the last digit of a group and the first digit of another group is longer still. Image processing 15 thus provides for generating a sequence of flash code numbers. A configuration parameter may be provided to adjust decoding time between flashes. For example, the time between long flashes could be set to 0.25 secs., 0.50 secs., 0.75 secs., or some other period.

The flash code numbers provide keys to be applied (step 17) to a look up table (LUT) 19 (either local or remote) which returns the associated fault code messages. These messages can be displayed (step 21) in human language text description on display 60. Step 21 may be executed as a loop which the technician can step through. The process than ends (step 23) once all faults have been displayed.

What is claimed is:

1. A diagnostic tool for a motor vehicle, comprising:
a handheld device including a video capture feature and a display;
the video capture feature having a field of view;
an application installed on the handheld device for qualifying a series of flashes captured in video frames by the video capture feature as corresponding to a vehicle diagnostic flash code; and
a processor in the handheld device responsive to qualification of a vehicle diagnostic flash code for decoding the flash code and displaying a textual description corresponding to the vehicle diagnostic flash code on the display.

2. The diagnostic tool of claim 1, further comprising:
a database relating flash codes to text messages identifying a fault or condition.

3. The diagnostic tool of claim 2, further comprising:
the handheld device being a cell telephone.

4. The diagnostic tool of claim 2, further comprising:
the database being remote; and
the application being adapted to establish a cell telephone link to access the database.

5. The diagnostic tool of claim 2, further comprising:
memory allowing storage of the database on the handheld device.

6. An installable application for a handheld electronic device having a video capture feature, the installable application comprising:
means for locating a flashing light source within a field of view of the video capture feature;
means for qualifying a series of flashes within the field of view as a vehicle diagnostic flash code and determining a number for the flash code; and
means for retrieving a text message correlated with the number for the flash code; and
means for displaying the text message.

7. The installable application of claim 3 wherein the handheld electronic device is a cellular telephone and the means for retrieving include a remote database accessed by a cellular telephone link.

8. A method of decoding motor vehicle diagnostic flash codes comprising the steps of:
recording a series of image frames of an instrument cluster for a motor vehicle equipped to display diagnostic flash codes in a video buffer;
electronically processing the series of image frames to locate a flashing light source recorded in the series of image frames;
qualifying the flashing light source as a source of diagnostic flash codes;
generating numbers corresponding to diagnostic codes from the diagnostic flash codes;
interrogating a memory device to recover text messages corresponding to the numbers; and
displaying the text messages on a display device.

9. The method of claim 8 wherein the step of interrogating a memory device includes making a cellular telephone call to a remote server supporting database.
